(19) United States
(12) Patent Application Publication
(10) Pub. No.: US 2013/0009577 A1
(43) Pub. Date: Jan. 10, 2013

(54) SYSTEM FOR CONTROLLING A MOTOR

(75) Inventor: Wei Shang, Pudong Shanghai (CN)

(73) Assignee: EBM-PAPST VENTILATOR (SHANGHAI) CO., LTD., Pudong Shanghai (CN)

(21) Appl. No.: 13/277,357

(22) Filed: Oct. 20, 2011

(30) Foreign Application Priority Data
Jul. 8, 2011 (CN) 201120240806.X

(51) Int. Cl. H02P 6/16

(52) U.S. Cl. 318/400.04

(57) ABSTRACT

A system for controlling a motor is provided. The system for controlling the motor includes a sensor for sensing position information of a rotor of the motor, a processor for receiving the sensed signal from the sensor and estimating an electrical angle on the basis of the sensed signal, and a control signal generating module for generating a control signal used to control the operation of the motor based on the electrical angle. The system can obtain the necessary control signal for controlling the motor only by one sensor, thereby reducing the complexity of installation of the sensors in the motor and also saving the cost.

### CROSS REFERENCE TO RELATED APPLICATIONS

The present application claims priority to pending Chinese Patent Application No. 201120240806.x, filed Jul. 8, 2011, the contents of which are incorporated by reference in its entirety.

### TECHNICAL FIELD

The invention relates to the technique for controlling of a motor.

### BACKGROUND

Generally, position information of a rotor is necessary for generating control signal in various types of motors for controlling the operation of these motors, such as Permanent Magnet Synchronous Motor and Brushless Direct Current Motor.

The positions of the rotor are detected by installing position sensors such as three Hall position sensors in the motor. In this case, the cost is increased due to requiring several position sensors while the complexity of installation of the position sensors is also increased since the sensors have to be fixed to the motor in certain manner. A China patent application No. CN200810181799.3 discloses a motor with three Hall position sensors.

In view of such question, the technology relating to no position sensor being used in the motor has been focused on in recent years. For example, the paper titled “a method for controlling a permanent magnet motor without position sensors”, Power Electronics, Vol. 2, 2007. In such way, the position sensor is not necessary; however, certain sensors such as a current sensor and a voltage sensor are still necessary. Therefore, the installation of several sensors in the motor still exists and the cost due to the sensors may not be reduced. Furthermore, not all types of motors can be controlled without position sensors. It is also found that the capacity of the motor system without position sensors is less good, thereby only can be used in the environment with low requirement.

### SUMMARY OF THE INVENTION

In view of the foregoing, it is an object of this invention to provide a system for controlling the motor such that above mentioned and other problems can be addressed. The system for controlling the motor may include one sensor for sensing position information of a rotor of the motor, a processor for receiving the sensed signal from the sensor and estimating an electrical angle on the basis of the sensed signal, and a control signal generating module for generating a control signal used to control the operation of the motor based on the electrical angle.

According to the system for controlling the motor, the processor may preferably include a sensor signal receiving unit used for receiving the sensed signal from the sensor, a rotate speed obtaining unit used for obtaining the rotate speed information of the rotor of the motor, and a computing unit used for estimating the electrical angle based on the sensed signal and the rotate speed information.

According to for controlling the motor, the processor may preferably include an error obtaining unit for obtaining error parameters.

According to for controlling the motor, the control signal generating module may include a waveform generating unit used for generating waveform control signal based on the electrical angle, and a drive unit used for generating the control signal based on the signal generated from the waveform generating unit.

Preferably, said one sensor for sensing position information of a rotor of the motor can be a position sensor. Further, the position sensor is preferred to be a Hall position sensor.

The control signal for controlling the operation of the motor is obtained on the basis of rotor's position information of the motor which is obtained by using only one sensor to sense the zero point of the rotor's position, according to the present invention. Only one sensor is used for sensing according to the present invention to achieve the capability which can be produced by using three sensors according to the conventional technology. Therefore the desired technical effect can be generated while the cost is also be reduced for only one sensor is required than three.

### BRIEF DESCRIPTION OF THE DRAWINGS

In the following, the invention will be described in details with reference to an example and the appended drawings, wherein,

FIG. 1 illustrates a block diagram of a system for controlling a motor according to an embodiment of the present invention; and

FIG. 2 illustrates a block diagram of a processor of the system for controlling the motor according to an embodiment of the present invention.

### DETAILED DESCRIPTION

The present invention will be described more fully with reference to the accompanying drawings, in which various embodiments are shown. This invention may, however, be embodied in many different forms and should not be constructed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “comprising”, “including”, and variants thereof, when used in this specification, specify the presence of stated features, elements, and/or components, but do not preclude the presence or addition of one or more other features, elements, components, and/or groups thereof.

In brief, position information of a rotor of a motor is obtained, according to the present invention, from a zero point position of the rotor which is determined by only using one sensor, instead of being directly obtained by three sensors as the conventional technology.

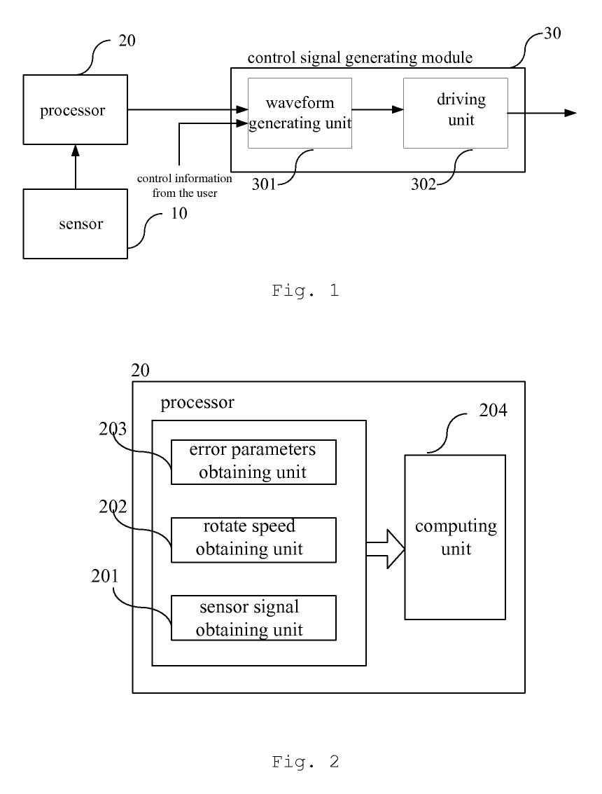

FIG. 1 illustrates a block diagram of a system for controlling a motor according to an embodiment of the present invention. The system for controlling the motor includes a sensor 10 used to sense the position information of the rotor of the motor, a processor 20 used to receive the signal sensed by the sensor 10 and then estimate the electrical angle based on this signal, and a control signal generating module 30 used to generate a control signal from the electrical angle estimated by the processor 20 for controlling the motor. Briefly, the system for controlling the motor coupled to the motor obtains the changes in mechanical position of the rotor to generate the control signal for controlling the operation of the motor from the obtained changes in mechanical position. It shall be understood that the system for controlling the motor herein can be used to control various motors.

The sensor 10 is provided in the motor to sense the position information of the rotor. The term “position information” herein refers to changes of the rotor in mechanical position, which also can be termed the information of the rotor with respect to the zero point which can be predetermined by the user. The sensor 10 can be any type of sensors which can be used for sensing the position, such as the Hall position sensor, the fiber sensor, and the like. According to the embodiment of the present invention, only one sensor 10 is required in controlling the motor. Therefore, the complexity of installation of the sensor in the motor is reduced compared to the conventional technology where three sensors have to be installed in the motor. At the same time, with only one sensor being required according to the present invention instead of three, the cost is also reduced. For clarity, the term “information of the rotor with respect to the zero point” is referred to as “information of the zero point” hereinafter.

The sensor 20 receives the signal sensed by the sensor 10, i.e., the sensed position information. Further, the sensor 20 estimates the electrical angle of the rotor from the sensed signal. Preferably, both of a previous rotate speed of the rotor and an aimed rotate speed are also taken into consideration by the processor 20 in estimating the electrical angle of the rotor. More preferably, the error parameters are also considered by the processor 20. The processor 20 can further include a sensor signal receiving unit 201, a rotate speed obtaining unit 202, error parameters obtaining unit 203, and a computing unit 204, in which the sensor signal receiving unit 201 receives the signal from the sensor 10, the rotate speed obtaining unit 202 obtains the previous rotate speed and the aimed rotate speed, and the error parameters obtaining unit 203 obtains the error parameters, i.e., the error accumulation. The error accumulation herein can be an error correction factor determined from the experience data and from the specific analysis of the particular motor system. As an example, the previous rotate speed can be obtained by the means as follows: registering a time T1 when the rotor triggers the predetermined zero point during rotating in the previous cycle, registering a time T2 when the rotor triggers the predetermined zero point during rotating in the current cycle, and determining approximately the previous rotate speed of the rotor from the distance of the cycle which is known and the difference of the times T2 and T1, in which the times T1 and T2 can be for example registered by a timer or obtained from the zero point information sensed by the sensor 10. As an example, the aimed rotate speed can be a predetermination of the user. The computing unit 204 computes the electrical angle of the rotor from the information provided by the sensor signal obtaining unit 201, the rotate speed obtaining unit 202, and the error parameters obtaining unit 203. The term “electrical angle” has a common meaning as those skilled in the art known, namely, the mechanical angle rotated by the rotor at per magnetic field changing.

The control signal generating module 30 receives the signal relating to the electrical angle transmitted from the processor 20, and then generates the control signal based on the received signal for controlling the operation of the motor. As an example, the control signal generating module 30 can include a waveform generating unit 301 and a driving unit 302. Alternatively, the control signal generating module 30 can take the relating controlling information for example input by the user into consideration in addition to the electrical angle. The waveform generating unit 301 generates waveform control signal from the electrical angle, for example, the waveform generating unit 301 generates Pulse-Width Modulation (PWM) signal. After being sent to the driving unit 302, the PWM signal is magnified to produce a PWM drive signal. The PWM drive signal is then transmitted to the motor to control its operation.

The modules and units as above described can be implemented in software, hardware, or combination of the both in practice.

As above described, the system for controlling the motor according to the present invention can obtain the position information of the rotor of the motor by only one sensor. The system then can estimate the electrical angle of the rotor of the motor based on the sensed position information, thereby producing the control signal for controlling the operation of the motor. With only one sensor being employed, the installation of the sensor in the motor is simplified in comparison with the conventional technology where at least three sensors are used and thus have to be installed. Also, the cost are reduced compared to the conventional technology since only one sensor is required than three. Furthermore, the system for controlling the motor has no necessary to detect the back electromotive force (BEMF) and the like. Also, the system is likely to implement the more complex algorithm for controlling. Further, the no position sensor system for controlling the motor is limited to the Y type of motor, i.e., it can not be applied to the Δ type of motor. The no position sensor system is only applied in the environment with less high requirements for the capability since it can not realize the more complex algorithm for controlling. However, the system for controlling the motor according to the present invention can be applied to various motors without such limiting.

What is claimed:

1. A system for controlling a motor, including one sensor for sensing position information of a rotor of the motor, a processor for receiving the sensed signal from the sensor and estimating an electrical angle on the basis of the sensed signal, and a control signal generating module for generating a control signal used to control an operation of the motor based on the electrical angle.

2. The system of claim 1, wherein the processor includes a sensor signal receiving unit for receiving the sensed signal from the sensor, a rotate speed obtaining unit for obtaining the rotate speed information of the rotor of the motor, and a computing unit for estimating the electrical angle based on the sensed signal and the rotate speed information.

3. The system of claim 2, wherein the processor includes an error obtaining unit for obtaining error parameters.

4. The system of claim 1, wherein the control signal generating module includes a waveform generating unit used for generating waveform control signal based on the electrical angle, and a drive unit used for generating the control signal based on the signal from the waveform generating unit.

5. The system of claim 2, wherein the control signal generating module includes a waveform generating unit used for generating waveform control signal based on the electrical angle, and a drive unit used for generating the control signal based on the signal from the waveform generating unit.

6. The system of claim 1, wherein the sensor is a position sensor.

7. The system of claim 2, wherein the sensor is a position sensor.

8. The system of claim 6, wherein the position sensor is Hall position sensor.

9. The system of claim 7, wherein the position sensor is Hall position sensor.
